(19) United States
(12) Patent Application Publication
(10) Pub. No.: US 2003/0174771 A1
(43) Pub. Date: Sep. 18, 2003

(54) Method, apparatus, and program for variable bit rate encoding

(75) Inventors: Takayuki Sugahara, Yokosuka-shi (JP); Juichi Shikunami, Kanagawa-ken (JP); Ken Miyazaki, Yokohama-shi (JP)

Correspondence Address: CONNOLLY BOVE LODGE & HUTZ LLP, SUITE 800, 1990 M STREET NW, WASHINGTON, DC, 20036-3425, US

(73) Assignee: Victor Company of Japan, LTD

(21) Appl. No.: 10/385,452

(22) Filed: Mar. 12, 2003

(30) Foreign Application Priority Data
Mar. 12, 2002 (JP) 2002-066550

(51) Int. Cl. H04N 7/12

(52) U.S. Cl. 375/240.03; 375/240.1

(57) ABSTRACT

A method for variable bit rate encoding is composed of a step of obtaining first encoded data by encoding a video signal in a predetermined bit rate, a step of recording the first encoded data, a step of observing encoded information of the recorded first encoded data, a step of decoding the recorded first encoded data at a predetermined time interval, a step of obtaining second encoded data by encoding the decoded first encoded data in variable bit rate at the predetermined time interval on the basis of either one of a combination of the encoded information and an average variable bit rate to be targeted and another combination of the encoded information and information related to a target code rate, and a step of recording the second encoded data encoded in the variable bit rate. The method for variable bit rate encoding records the first and second encoded data in a recording medium while buffering the first and second encoded data respectively in the steps of recording the first and second encoded data.

### BACKGROUND OF THE INVENTION

1. Field of the Invention

The present invention relates to a method, an apparatus, and a program for variable bit rate encoding. The method and the apparatus can encode a moving picture or a video signal through the orthogonal transformation and the quantization and are applicable for encoding a video signal, particularly, relates to a method, an apparatus, and a program for variable bit rate encoding, which are characterized in that constant bit rate encoded data are converted into variable bit rate encoded data in a predetermined time unit after the constant bit rate encoded data are temporarily recorded.

2. Description of the Related Art

According to the Japanese Patent Laid-open Publication No. 7-284097/1995 that is one example of conventional variable bit rate encoding technology, a video signal is divided into two passes, a first pass and a second pass, and they are encoded respectively. In the first pass, information necessary for encoding the second pass is produced and outputted. In this case, a particular encoding method such as the MPEG is used for encoding the first and second passes.

With respect to the MPEG, it is detailed in the Standards ISO-IEC 11172-2 and ITU-T H.262/ISO-IEC 13818-2, so that only their outlines are explained hereinafter.

MPEG is an abbreviation of the organization, namely Moving Picture Experts Group, that is established so as to study a standard for moving picture encoding system in the Subcommittee 2 (SC2) under the Joint Technical Committee 1 (JTC1) between International Standard Organization (ISO) and International Electrotechnical Commission (IEC), namely ISO/IEC JTC 1/SC2, wherein the Subcommittee 2 has been renamed as the Subcommittee 29 (SC29). The MPEG Phase 1 (MPEG-1) is the standard for storage media having a bit rate of the order of 1.5 Mbps. The MPEG-1 has inherited fundamental technologies from JPEG (Joint Photographic Coding Group) that is intended for encoding still pictures and H.261 that is intended for compressing moving pictures in low bit rate for a teleconference and a TV-phone through ISDN (Integrated Services Digital Network) telephone lines, and has been introduced with new technologies for storage media. The H.261 has been standardized by the Study Group 15 of Comite Consul tatif International Telegraphique et Telephoniqur/International Telegraph and Telephone Consultative Committee (CCITTSGXV), that is, the Study Group 15 of International Telecommunication Union—Telecommunication Standardization Sector (ITU-T SG15) currently. The MPEG-1 family standards were issued as ISO/IEC11172 in August 1993.

Further, the MPEG-1 is established by combining several technologies.

Obtaining a difference between a picture signal decoded by a motion compensator and an inputted picture signal reduces temporal redundancy components from the inputted picture signal.

With respect to a method of prediction, there existed three modes as basic modes. The first one is a mode of predicting from a past picture, the second one is a mode of predicting from a future picture, and the third one is a mode of predicting from both past and future pictures. These three modes can be used by switching over from one to the other at every one macroblock (MB) that is composed of 16 pixels by 16 pixels (16×16).

With respect to picture types, a first one is a unidirectionally predictive encoded picture (P-picture), a second one is a bidirectionally predictive encoded picture (B-picture), and a third one is an intra encoded picture (I-picture). In a P-picture, there existed two modes: a mode that predicts from a past picture that is decided by a picture type (Picture_Type) given to an inputted picture and encodes, another mode that encodes independently a macroblock without prediction. In a B-picture, there existed four modes: a first mode of predicting from a future picture and encoding, a second mode of predicting from a past picture and encoding, a third mode of predicting from both past and future pictures and encoding, and a fourth mode of encoding independently without prediction. Encoding all macroblocks independently is an I-picture.

Further, an I-picture is called as an intra picture. Therefore, a P-picture and a B-picture can be called as a non-intra picture.

With respect to motion compensation, a motion vector is detected with an accuracy of half pel (pixel) by performing pattern matching on a motion area at every one macroblock. Shifting the motion vector by an amount as much as its detected movement and predicting compensates motion. In one motion vector, there existed motion vectors in the horizontal and vertical directions. They are transmitted as an additional information together with a motion compensation (MC) mode that indicates prediction from which direction.

FIG. 5 is a block diagram showing a basic configuration of a video signal encoder according to the prior art. In FIG. 5, an input picture signal is supplied to an input terminal 101. The inputted picture signal is transmitted to an arithmetic unit 102 and a motion compensation predictive unit 111.

The arithmetic unit 102 obtains a difference between a picture signal decoded by the motion compensation predictive unit 111 and the inputted picture signal, and the differential picture signal is transmitted to a DCT (discrete cosine transform) unit 103.

The DCT unit 103 applies the orthogonal transformation to the differential picture signal supplied from the arithmetic unit 102. The DCT (discrete cosine transform) is the orthogonal transformation that transforms the integral transformation, which assigns a cosine function as an integrating kernel, into the discrete transformation to a finite space. In the case of MPEG, the two-dimensional DCT is applied to a DCT block of 8×8 (8 pixels by 8 pixels) that is formed by dividing one macroblock into four blocks. Generally, a video signal contains more low frequency components and fewer high frequency components, so that coefficients concentrate to a lower frequency range when the DCT is applied.

Data (DCT coefficient) obtained by the DCT in the DCT unit 103 are quantized by a quantization unit 104. The quantization in the quantization unit 104 is such that the DCT coefficient is divided by a quantization value, which is a value of multiplying a value, namely quantizer matrix, that is obtained by weighting two-dimensional frequency of 8×8 by visual characteristic by another value, namely quantizer scale factor, that is scalar multiples of the total weighted value.

In the case that encoded data, which has been encoded by the video signal encoder, is decoded by a video signal decoder (will be explained later) and dequantized, multiplying the quantization value that is used in the video signal encoder as mentioned above can obtain a value approximated to the DCT coefficient.

The data quantized by the quantization unit 104 is encoded in a variable length code (VLC) by a VLC unit 105. The VLC unit 105 encodes a DC (direct current) component out of quantized values through the DPCM (differential pulse code modulation) method that is one of the predictive encoding methods. On the contrary, with respect to an AC (alternating current) component, the VLC unit 105 scans from a lower frequency to a higher frequency, that is, scans the AC component zigzag, namely zigzag scan, and allocates a short length code in the order of decreasing cumulative frequency with defining run length of zeros and an effective coefficient value as one phenomenon, in other words, namely the Huffman coding method is applied.

The data encoded in the variable length code by the VLC unit 105 is temporarily stored in a buffer memory 106, and then read out from the buffer memory 106 in a predetermined bit rate and outputted from an output terminal 107 as encoded data or an encoded bit stream.

Further, a generated code amount per each macroblock in the encoded data to be outputted is transmitted to a code rate controlling unit 113 by way of a buffer managing unit 114 (will be detailed later). The code rate controlling unit 113 obtains difference between a target code rate and the generated code amount per each macroblock and controls the generated code amount by generating a code rate control signal corresponding to the difference and feeding back the code rate control signal to the quantization unit 104. The code rate control signal that is fed back to the quantization unit 104 for the purpose of controlling the code rate is a signal so as to control quantizer scale in the quantization unit 104. An actual controlling method of code rate will be mentioned later.

On the other hand, the quantized picture data are transmitted to a dequantization unit 108 and dequantized therein.

Further, DCT coefficient data that are obtained through the dequantization are transmitted to an inverse DCT unit 109 and processed by the inverse DCT, and then the picture signal is restored in an arithmetic unit 112 by adding a predictive differential picture transmitted from the motion compensation predictive unit 111.

The restored picture signal is temporarily stored in a picture memory 110, and then transmitted to the motion compensation predictive unit 111. The picture signal transmitted to the motion compensation predictive unit 111 from the picture memory 110 is used for producing a decoded picture that is a reference for calculating a differential picture in the arithmetic unit 102.

Furthermore, in the case of a video signal, the encoded bit stream that is the encoded data to be outputted from the output terminal 107 has a code rate in variable length per each picture. This is caused by that the MPEG adopts information transformation methods such as DCT, quantization and Huffman coding, and at the same time caused by that a code rate, which is distributed to each picture to improve picture quality, is altered so as to be adaptable. In other words, since the motion compensation prediction is performed in the MPEG process, entropy of encoded picture itself changes extremely such that sometimes an inputted picture signal is encoded as it is and in some cases a differential picture signal, which is a difference between a predictive picture and the inputted picture signal, is encoded. In this case, limiting code rate is enforced with keeping limitation for capacity of buffer memory while most of code rate is distributed in accordance with a picture entropy ratio.

Consequently, the buffer managing unit 114 observes a relationship between a code rate generated by encoding and a usable encode rate, and sets a target code rate so as to be stored within a predetermined buffer capacity of the buffer memory 106.

An information corresponding to a difference of actually generated code amount from the target code rate is fed back to the VLC unit 105 and inputted to the code rate controlling unit 113. The code rate controlling unit 113 suppresses a generated code amount by increasing a quantizer scale factor that is set in the quantization unit 104 or, on the contrary, produces a code rate controlling signal for decreasing a generated code amount by decreasing a quantizer scale factor.

As mentioned above, in the case of transmitting variable length data as constant bit rate data or constant bit rate encoded data, a maximal buffer amount of a video signal decoder to be a receiver side for the data becomes the upper limit value of generated code amount of a video signal encoder in a transmitter side. In other words, in a case of using a model of virtual decoder that momentarily decodes encoded data inputted in a constant velocity when the encoded data are accumulated as many as a predetermined value at a predetermined time, wherein the predetermined time is the unit of 1/29.97 sec. if the video signal is based on the NTSC color TV broadcasting system, a bit rate in a virtual buffer memory, namely VBV buffer, of the model becomes a constant bit rate if an observation duration is made longer although the bit rate varies locally. The MPEG standard defines this bit rate as a constant rate.

In the case of a constant bit rate defined as mentioned above, if a generated code amount in the encoder side is small, a buffer occupying amount keeps sticking to the upper limit value in the decoder side. In this case, a code rate in the encoder side must be increased by adding an invalid bit, for example, in order for a buffer (VBV buffer) not to overflow.

On the other hand, in the case of a variable bit rate, by expanding the definition of constant bit rate, it is defined that overflow does not occur basically by suspending readout in the decoder when the buffer occupying amount becomes the upper limit value. Consequently, in the case of a variable bit rate, even if a generated code amount is extremely small, readout in the decoder is suspended, so that an invalid bit is not necessary to be inserted unlike the case of the constant bit rate. Therefore, in the case of a variable bit rate, data are encoded such that only underflow does not occur. With these technologies as background, in the conventional variable bit rate encoding, such a technology as dividing a video signal into a first pass and a second pass, encoding, and outputting a necessary information for encoding the second pass in the first pass is explained next.

FIG. 6 is a block diagram showing a configuration for encoding a first pass according to the prior art. In FIG. 6, the same reference number as shown in FIG. 5 is given to components, which operate or function identically to those components of the basic configuration shown in FIG. 5, and details of their operations and functions are omitted.

In the configuration of encoding the first pass shown in FIG. 6, a video signal is reproduced and inputted to the input terminal 101. An information about generated code amount that is generated at every short interval with respect to total video sequence is added to an encoding information at the moment. The generated code amount is calculated by a code rate counter 121 after encoded through the VLC (variable length code) process by the VLC unit 105, transmitted to a memory circuit 122, and then stored therein. Any kind of storage media in high speed such as solid-state memory, hard disc or optical disc can be applied for the memory circuit 122.

Further, the first pass is used for an extent of monitoring whether or not accurate compression has been done. Therefore, the buffer memory 106 and the succeeding output terminal 107 for encoded data is not always essential as far as an encoded code amount can be counted although they are illustrated in FIG. 6.

The variable length encoding is performed in an encoding method such as represented by MPEG. Therefore, a generated code amount increases in accordance with complexity of an encoded picture and a differential amount or remaining differential component of motion compensation if the first pass is encoded with keeping quantizer width fixed.

Consequently, picture quality can be made uniform if a generated code amount is distributed by using the characteristic mentioned above.

Further, in the case of encoding the second pass that will be mentioned later, it is essential to control a generated code amount to be a target code rate of the total as well as maintaining a distribution ratio of the code rate.

A generated code amount is detected by the unit of short interval generated by encoding a first pass, and obtained information about the generated code amount are stored in the memory circuit 122. With respect to an example of short interval, one GOP (group of picture) of the order of 15 pictures, which can divide one picture by each intra encoding unit, is considered. In this case, the memory circuit 122 stores an information about how many code rates have been generated per each GOP unit.

With respect to encoding the first pass, generally a quantizer width is set to a relatively narrower and fixed width, and commonly more code rates than an eventual code rate that is outputted in the second pass are generated. As mentioned above, narrowing the quantizer width while encoding the first pass is necessary to decompose information of a picture so far as high frequency components minutely and to detect a characteristic of the picture.

In the first pass, a code rate that is generated during an “i-th” short interval is defined as PS1B(i).

Further, a code rate generated at each short interval in the first pass is defined as a target code rate of each short interval in the second pass. If a short interval is defined as one GOP, for example, a code can be controlled by a following method while maintaining picture quality in a certain grade.

FIG. 7 is a block diagram showing a configuration for encoding a second pass according to the prior art. In FIG. 7, the same reference number as shown in FIG. 5 is given to components, which operate or function identically to those components of the basic configuration shown in FIG. 5, and details of their operations and functions are omitted.

In the configuration of second pass shown in FIG. 7, quantizer scale is reduced in order to increase a generated code amount. On the contrary, quantizer scale is increased in order to decrease a generated code amount. By using this principle, a method of controlling a quantizer width can be considered on the basis of an occupation ratio of the buffer memory 56, for example. Points to which attention should be paid hereupon is that a P-picture (unidirectionally predictive encoded picture) is predicted from a preceding I-picture (intra encoded picture) or a preceding P-picture, and that a B-picture (bidirectionally predictive encoded picture) is predicted form an I-picture and a P-picture disposed in both sides of the B-picture temporally. Therefore, if an I-picture, for example, is deteriorated, the other pictures are also deteriorated with being interlocked with the I-picture.

In an example of method mentioned below, controlling a code rate in total is realized with considering distribution of code rate with respect to a picture.

In a target code rate deciding circuit 26, by using a generated code amount PS1B(i) obtained in the first pass from a memory circuit 22, a target code rate PS2B(i) of each GOP is obtained by a following equation.

PS2B(i)=“final target of total code rate”×PS1B(i)/ΣPS1B(i),

wherein actual controlling of code rate is performed by a code rate controller 65 through an algorithm such as first and second steps mentioned below with assuming that a target code rate PS1B(i) given to one GOP is “R”.

(A) First Step: In a first step, a code rate to be assigned to each picture of one GOP is distributed to pictures that are not encoded yet in the GOP with weighting as shown in following equations.

Xi=Si×Qi,

Xp=Sp×Qp, and

Xb=Sb×Qb,

where “X” is called a “global complexity measure” and defined by a product of generated code amount “S” that is a result of encoding a preceding same Picture_Type and an average quantizer scale “Q”, “i”, “p” and “q” represents I-picture, P-picture and B-picture respectively.

Further, a quantizer scale that achieves ideal picture quality is assumed that a ratio of a P-picture to an I-picture as a reference is 1.0 (Kp=1.0), and a ratio of a B-picture to an I-picture as a reference is 1.4 (Kb=1.4).

Code rates Ti, Tp and Tb of each picture that are allocated in the first step hereat can be obtained by following equations.

Ti=MAX{R/[1+(NpXp/XiKp)+(NbXb/XiKb)], br/(8*pr)},

Tp=MAX{R/[Np+(NpKpXb/KbXp)], br/(8*pr)} and

Tb=MAX{R/[Np+(NpKbXp/KbXp)], br/(8*pr)},

wherein “Ti” is a code rate of I-picture, “Tp” is a code rate of P-picture, “Tb” is a code rate of B-picture, “MAX” is maximum, “R” is a code rate of an initial value given to a GOP, “Np” is a number of pictures that are not encoded out of P-pictures in the GOP, “Nb” is a number of pictures that are not encoded out of B-pictures in the GOP, “pr” is a picture rate and “br” is a bit rate respectively.

Additionally, the code rate “R” of an initial value is renewed as shown below in accordance with progress of encoding in the GOP.

R=R−Si,p,b

(B) Second Step: In a second step, in order to coincide the code rates (Ti, Tp and Tb) of each picture assigned in the first step with actual generated code amounts, as shown in following equations, a difference of a target code rate from a predicted target code rate in the middle is fed back to a quantizer scale by the macroblock unit while adding a generated code amount by the macroblock unit.

dⱼⁱ=d₀ⁱ+Bⱼ₋₁−[Tᵢ(j−1)/MB_{—}cnt],

dⱼ^{p}=d₀^{p}+Bⱼ₋₁−[Tₚ(j−1)/MB_{—}cnt], and

dⱼ^{b}=d₀^{b}+Bⱼ₋₁−[T_{b}(j−1)/MB_{—}cnt],

wherein “d₀ⁱ” is initial fullness of virtual buffer (VBV buffer) in an I-picture, “d₀^{p}” is initial fullness of virtual buffer (VBV buffer) in a P-picture, “dob” is initial fullness of virtual buffer (VBV buffer) in a B-picture, “j” is a number showing a sequence number from the head of each picture that is counted by a code rate counter, “Bⱼ₋₁” is a generated code amount from the head to the (j−1)-th macroblock of each picture that is counted by the code rate counter, “MB_cnt” is a number of macroblocks in one picture, “dⱼⁱ” is a feedback amount of an I-picture, “dⱼ^{p}” is a feedback amount in a P-picture and “dⱼ^{b}” is a feedback amount in a B-picture respectively.

Further, the average quantizer scale “Q” can be obtained by the following equations:

Q=dj×31/r, and

R=2×br/pr,

wherein “Q” is a quantizer scale and “r” is a parameter that decides a response rate of feedback. In the conventional configuration, performing each of the arithmetic operations mentioned above enables controlling a code rate.

With referring to FIG. 8, a standard operation of a conventional decoder is explained next. FIG. 8 is a block diagram showing a configuration of a conventional video signal decoder according to the prior art. In FIG. 8, an encoded stream is buffered by a buffer memory 73 and data from the buffer memory 73 is inputted to a VLD (Variable Length Decode) unit 74. In the case of decoding data in a variable bit rate, it is necessary for the decoder that reading out from a recording medium is interrupted temporarily if the buffer memory 73 is in fully stored condition and reading out is enabled when the buffer memory 73 becomes lower than a predetermined value from the fully stored condition. The data are processed through the variable length decoding by the VLD unit 74 and DC and AC components are obtained. AC component data are disposed in a matrix of 8×8 through the zigzag scanning from a lower frequency to a higher frequency. The data disposed in the matrix of 8×8 are inputted to a dequantization unit 75 and dequantized by a quantization matrix. The dequantized data are inputted to an inverse DCT unit 76 and outputted as picture data, that is, decoded data through the inverse DCT 76.

Further, the decoded data are stored in a picture memory 79 temporarily, and then the decoded data are used as a reference of decoded picture in order to calculate a differential picture in a motion compensation predictive unit 78.

The Japanese Patent Laid-open Publication No. 9-265730/1997 discloses that a time duration between reading out a disc and outputting decoded data is shortened without increasing a scale of circuitry or increasing a clock speed, for example, discloses a technology of reproducing data of a DVD (digital versatile disc) at a speed twice the regular speed and transporting through the ATAPI (AT Attachment Packet Interface).

Further, it discloses a technology that performs writing in and reading out from a buffer simultaneously.

In addition thereto, the Japanese Patent Laid-open Publication No. 11-234676/1999 discloses that a moving picture signal transmitted in real time is once recorded in the constant bit rate, and the encoded data in the constant bit rate are decoded, and then the decoded data are converted into data in variable bit rate.

As mentioned above, in order to realize the variable bit rate encoding by the conventional configuration of encoding method, the encoding of pass must be processed twice. In other words, as shown in FIGS. 6 and 7, a moving picture signal to be encoded must be inputted to a video signal encoder twice. Consequently, it is impossible for a picture signal such as a moving picture transmitted in real time through a broadcasting or telecommunications, which is transmitted once, to be encoded in variable bit rate.

Further, as disclosed in the Japanese Patent Laid-open Publication No. 11-234676/1999, inputting can be done once. However, the second variable bit rate encoding is performed after the first encoding has been done in constant bit rate and all the moving pictures have been recorded. Therefore, there existed a problem that requires a longer time period almost twice the time duration for inputting an input picture until final encoded data in variable bit rate are obtained.

### SUMMARY OF THE INVENTION

Accordingly, in consideration of the above-mentioned problems of the prior arts, an object of the present invention is to provide a method, an apparatus and a program for variable bit rate encoding, which can encode a moving picture signal transmitted in real time through a broadcasting or telecommunications in variable bit rate and further can edit the encoded data easily.

In order to achieve the above object, the present invention provides, according to an aspect thereof, a method for variable bit rate encoding, encoding a video signal through an orthogonal transformation and quantization, outputting an encoded video signal in variable bit rate, and recording the encoded video signal, the variable bit rate encoding method comprising the steps of: obtaining first encoded data by encoding a video signal through the orthogonal transformation and the quantization in a predetermined bit rate; recording the first encoded data; observing encoded information of the recorded first encoded data; decoding the recorded first encoded data at a predetermined time interval; obtaining second encoded data by encoding the decoded first encoded data in variable bit rate at the predetermined time interval on the basis of either one of a combination of the encoded information and an average variable bit rate to be targeted and another combination of the encoded information and information related to a target code rate; and recording the second encoded data encoded in the variable bit rate, the variable bit rate encoding method is further characterized in that the first and second encoded data are recorded in a recording medium while buffering the first and second encoded data respectively in the steps of recording the first and second encoded data.

According to another aspect of the present invention, there provided an apparatus for variable bit rate encoding, encoding a video signal through an orthogonal transformation and quantization, outputting an encoded video signal in variable bit rate, and recording the encoded video signal, the variable bit rate encoding apparatus comprising: a means for obtaining first encoded data by encoding a video signal through the orthogonal transformation and the quantization in a predetermined bit rate; a means for recording the first encoded data; a means for observing encoded information of the recorded first encoded data; a means for decoding the recorded first encoded data at a predetermined time interval; a means for obtaining second encoded data by encoding the decoded first encoded data in variable bit rate at the predetermined time interval on the basis of either one of a combination of the encoded information and an average variable bit rate to be targeted and another combination of the encoded information and information related to a target code rate; and a means for recording the second encoded data encoded in the variable bit rate, the variable bit rate encoding apparatus is further characterized in that the first and second encoded data are recorded in a recording medium while buffering the first and second encoded data respectively when recording the first and second encoded data.

According to a further aspect of the present invention, there provided a program for variable bit rate encoding, realizing functions of encoding a video signal through an orthogonal transformation and quantization, outputting an encoded video signal in variable bit rate, and recording the encoded video signal in a computer, the variable bit rate encoding program comprising the steps of: obtaining first encoded data by encoding a video signal through the orthogonal transformation and the quantization in a predetermined bit rate; recording the first encoded data; observing encoded information of the recorded first encoded data; decoding the recorded first encoded data at a predetermined time interval; obtaining second encoded data by encoding the decoded first encoded data in variable bit rate at the predetermined time interval on the basis of either one of a combination of the encoded information and an average variable bit rate to be targeted and another combination of the encoded information and information related to a target code rate; and recording the second encoded data encoded in the variable bit rate, the variable bit rate encoding program is further characterized by functions to be realized in the computer such that the first and second encoded data are recorded in a recording medium while buffering the first and second encoded data respectively in the steps of recording the first and second encoded data.

Other objects and further features of the present invention will be apparent from the following detailed description when read in conjunction with the accompanying drawings

### BRIEF DESCRIPTION OF DRAWINGS

FIG. 1 is a block diagram of a video signal encoding apparatus showing a configuration of converting first encoded data into encoded data in variable bit rate by observing through an encoding information observation equipment, wherein the video signal encoding apparatus is applied with a method for variable bit rate encoding, an apparatus for variable bit rate encoding and a program for variable bit rate encoding according to the present invention.

FIG. 2 is another block diagram of a video signal encoding apparatus showing a configuration of converting a first encoded data into an encoded data in variable bit rate by observing a generated code amount and a motion vector while encoding through an encoding information observation equipment, wherein the video signal encoding apparatus is applied with the method for variable bit rate encoding, the apparatus for variable bit rate encoding and the program for variable bit rate encoding according to the present invention.

FIG. 3 shows a format of encoding information (picture information) that is stored in a memory circuit according to the present invention.

FIG. 4 shows another format of encoding information (macroblock information) that is stored in the memory circuit according to the present invention.

FIG. 5 is a block diagram showing a configuration of a conventional video signal encoder according to the prior art.

FIG. 6 is a block diagram showing a configuration of encoding a first pass in a conventional video signal encoder according to the prior art.

FIG. 7 is a block diagram showing a configuration of encoding a second pass in a conventional video signal encoder according to the prior art.

FIG. 8 is a block diagram showing a configuration of a conventional video signal decoder according to the prior art.

FIG. 9 is a flow chart showing a process of converting first encoded data into encoded data in variable bit rate by observing through an encoding information observation equipment in a video signal encoding apparatus, wherein the video signal encoding apparatus is applied with the method for variable bit rate encoding, the apparatus for variable bit rate encoding and the program for variable bit rate encoding according to the present invention.

FIG. 10 is a flow chart showing a process of converting first encoded data into encoded data in variable bit rate by observing a generated code amount and a motion vector while encoding through an encoding information observation equipment in a video signal encoding apparatus, wherein the video signal encoding apparatus is applied with the method for variable bit rate encoding, the apparatus for variable bit rate encoding and the program for variable bit rate encoding according to the present invention.

FIG. 11 is a block diagram showing a configuration of a video signal decoding apparatus, which is applied with a variable bit rate decoding method, a variable bit rate decoding apparatus and a variable bit rate decoding program, according to the prior art.

FIG. 12 is a flow chart showing an operation of the video signal decoding apparatus shown in FIG. 11.

### DETAILED DESCRIPTION OF THE PREFERRED EMBODIMENTS

[Embodiment]

With referring to drawings, a variable bit rate encoding method, a variable bit rate encoding apparatus and a variable bit rate encoding program is explained next.

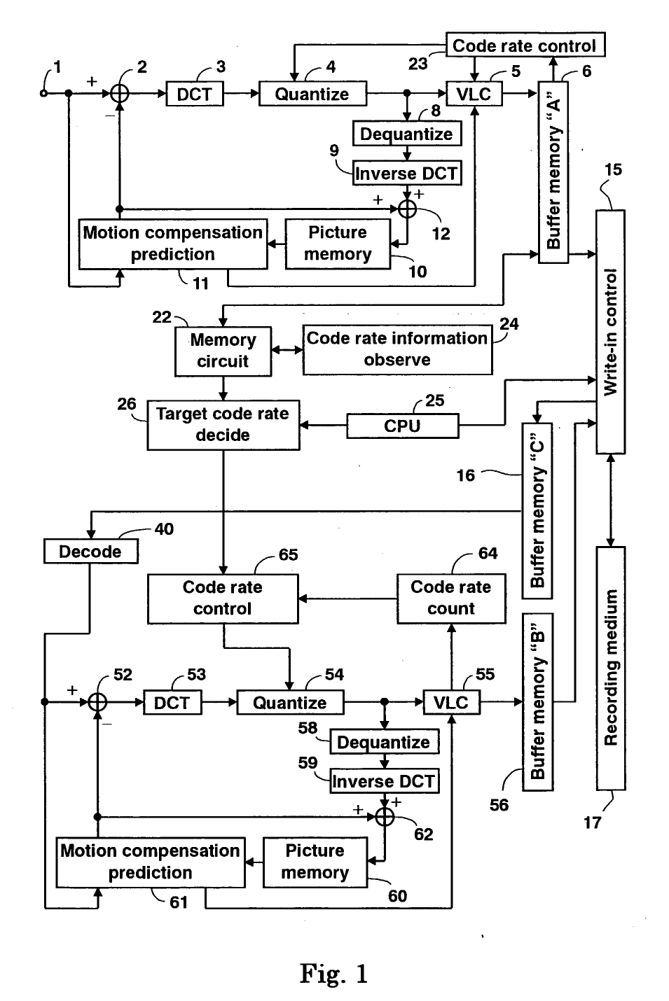

FIG. 1 is a block diagram showing one example of a video signal encoding apparatus that is applied with a method for variable bit rate encoding and an apparatus for variable bit rate encoding according to the present invention.

Further, in this embodiment, an encoding method for moving picture signal is explained by using the MPEG-1 encoding method as an example.

In FIG. 1, an input picture signal to be inputted to an input terminal 1 is a video signal that is composed of a luminance signal and a color difference signal, and pictures of the input picture signal are reordered in accordance with a picture type (Picture_Type) after digitized. In addition, FIG. 1 shows an example of configuration such that the input picture signal is recorded in a recording medium 17 as first encoded data in constant bit rate, for example.

Further, the first encoded data recorded in the recording medium 17 is read out by every predetermined time period and converted into a second encoded data in variable bit rate, and then the first and second encoded data are recorded.

The input picture signal supplied to the input terminal 1 is transmitted to an arithmetic unit 2 and a motion compensation predictive unit 11. In the motion compensation predictive unit 11, the input picture signal is processed through the motion compensation prediction in accordance with a sequential order of encoding. The arithmetic unit 2 calculates a difference between the input picture signal and a predictive picture from the motion compensation predictive unit 11.

Differential picture data obtained by calculation in the arithmetic unit 2 are processed through the discrete cosine transformation (DCT) method in a DCT unit 3. A quantizing unit 4 quantizes a DCT coefficient from the DCT unit 3. The quantized data are transmitted to a VLC unit 5 together with a motion vector and an encoding mode from the motion compensation predictive unit 11 and encoded in variable length code (VLC) by the VLC unit 5.

The encoded data obtained through the VLC encoding by the VLC unit 5 are stored in a buffer memory “A” 6 temporarily, and then outputted to a write-in control unit 15 from the buffer memory “A” 6 as a video stream of the MPEG. The write-in control unit 15 is managed by a CPU 25, and the video stream is outputted to the recording medium 17 together with a video stream from a buffer memory “B” 56 (will be explained later).

Further, a code rate control unit 23 observes a degree of sufficiency of the buffer memory “A” 6. The code rate control unit 23 feeds back an encoding control signal to the quantizing unit 4. Generally, the encoding control signal makes quantization roughly when the degree of sufficiency of the buffer memory “A” 6 increases, and makes quantization finely when the degree of sufficiency decreases. In other words, an encoding control signal to be fed back to the quantizing unit 4 is a control signal to control a quantization scale.

As mentioned above, an input picture signal is supposed to be encoded in constant bit rate that is defined by the MPEG standard. The encoded data in constant bit rate depend on a storage capacity of recording medium and a reproduction time of an input picture signal to be recorded. However, the bit rate is desirable to be extremely higher within the conditions of capacity and reproduction time, in other words, it is desirable for picture quality to be excellent, because a rate of the encoded data in constant bit rate is equal to a maximum bit rate of an encoding condition while transforming the encoded data in constant bit rate to an encoded data in variable bit rate (will be mentioned later).

Consequently, in this embodiment, encoded data in constant bit rate outputted from the buffer memory “A” 6 are recorded in the recording medium 17 through the write-in control unit 15. The write-in control unit 15 is managed by the CPU 25. The encoded data in constant bit rate are outputted to the recording medium 17 with bursting in together with data stored in the buffer memory “B” 56 when a predetermined code rate is accumulated so as not to overflow or underflow. In other words, the write-in control unit 15 records the encoded data in constant bit rate in the recording medium 17 with bursting in together with second encoded data that are encoded in variable bit rate and stored in the buffer memory “B” 56 temporarily in accordance with a degree of sufficiency of both the buffer memory “A” 6 and the buffer memory “B” 56.

Further, it is necessary for a buffer memory “C” 16, which is provided for reading first encoded data, to be read with bursting. The recording medium 17 is essential to ensure these operations. Therefore, a recording rate of the recording medium 17 must be set so as to enable to record at a speed more than the sum of rates of recording and reading sides of first encoded data and a peak rate of second encoded data. In other words, as far as the recording medium 17 is in disciform, the recording medium 17 can be rotated at a higher rotational speed and a recording system must be cope with high-speed recording as a result.

In addition, any kind of recording medium such as solid-state memory, hard disc, optical disc or high-speed storage medium can be applied for a recording medium to be utilized in this embodiment.

In the meantime, an I-picture (intra encoded picture) and a P-picture (predictive encoded picture) is essential to be used for a reference picture for motion compensation prediction in the later process. Therefore, quantized data of the I-picture and the P-picture are transmitted to a dequantizing unit 8 and succeeding components. In other words, DCT coefficient data obtained by the dequantizing unit 8 through the dequantizing process are transmitted to an inverse DCT unit 9 and transformed by the inverse DCT process therein. Then, an original picture signal is restored with adding a predictive differential picture from the motion compensation predictive unit 11 in an arithmetic unit 12. The restored picture signal is stored in a picture memory 10 temporarily. A picture signal that is restored and stored in the picture memory 10 is the same picture signal that is reproduced by a video signal decoding apparatus (will be mentioned later).

The picture signal stored in the picture memory 10 is transmitted to the motion compensation predictive unit 11 and referred to as a reference picture for following motion compensation prediction therein. In other words, the picture signal that is transmitted to the motion compensation predictive unit 11 from the picture memory 10 is used for producing a decoded picture as a reference for calculating a differential picture in the arithmetic unit 12.

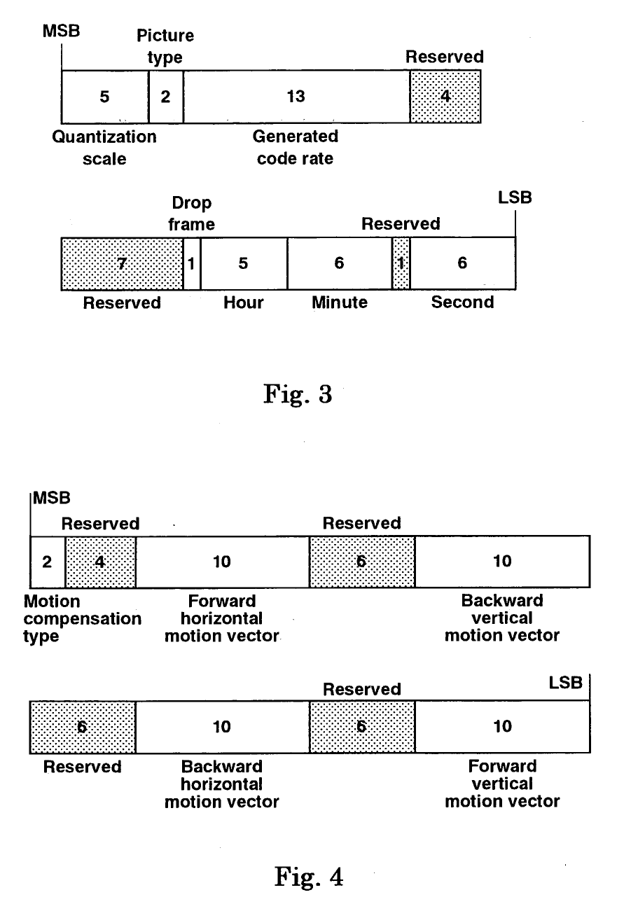

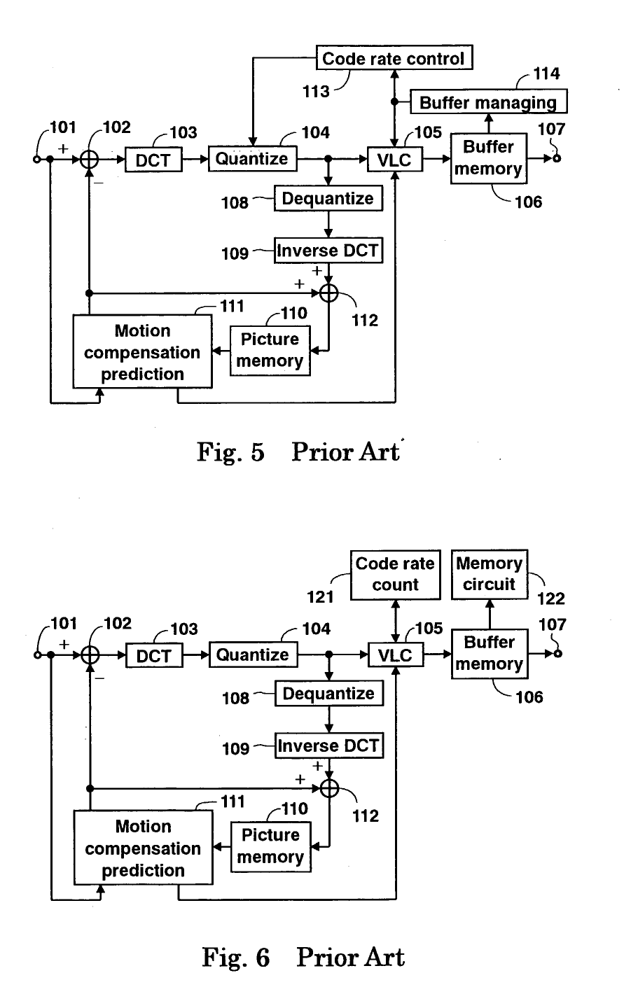

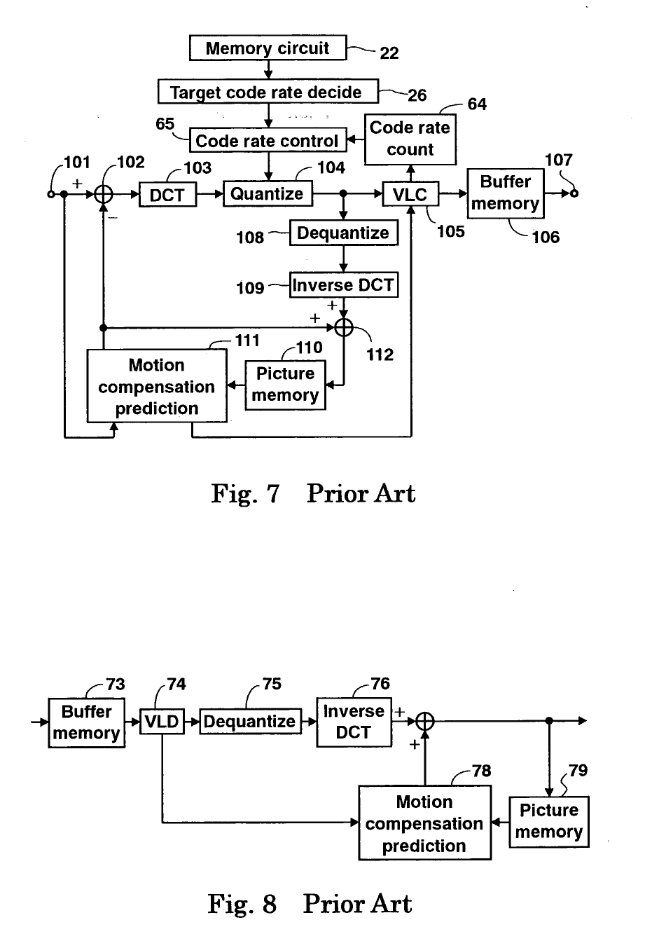

In the video signal encoding apparatus according to the embodiment of the present invention, encoded data are stored in a memory circuit 22 temporarily through the buffer memory “A” 6, and first encoded data recorded in the memory circuit 22 are transmitted to a code rate information observing unit 24. The code rate information observing unit 24 observes a generated code amount and a quantization scale of each picture in the first encoded data, transmits the generated code amount and the quantization scale to the memory circuit 22 again, and makes the memory circuit 22 record the generated code amount and the quantization scale. With respect to actual encoding information to be recorded in the memory circuit 22, there exists picture information having a format as shown in FIG. 3 and macroblock information having a format as shown in FIG. 4.

FIG. 3 shows a format of picture information that is stored in a memory circuit according to the present invention. In FIG. 3, the format is composed of 5 bits of “quantization scale” field, 2 bits of “picture type” field, 13 bits of “generated code amount” field, 4 bits of reserved field, 7 bits of reserved field, 1 bit of “drop frame” field, 5 bits of “hour” field, 6 bits of “minute” field, 1 bit of reserved field, and 6 bits of “second” field. The memory circuit 22 records the picture information in a sequential order of encoding as many as a number of pictures.

FIG. 4 shows a format of macroblock information that is stored in the memory circuit according to the present invention. In FIG. 4, the format is composed of 2 bits of “motion compensation type” field, 4 bits of reserved field, 10 bits of “forward horizontal motion vector” field, 6 bits of reserved field, 10 bits of “backward vertical motion vector” field, 8 bits of reserved field, 10 bits of “backward horizontal motion vector” field, 6 bits of reserved field, and 10 bits of “forward vertical motion vector” field. As shown in FIG. 4, the encoding information of macroblock are composed of motion compensation type information and motion vector information for motion compensation, and they are recorded in the memory circuit 22.

By using generated code amount information, quantization scale information and encoded data in constant bit rate recorded in the memory circuit 22, an actual configuration of transforming the first encoded data to second encoded data that are encoded data in variable bit rate is explained next.

When first encoded data are recorded up to a predetermined time interval, the CPU 25 transmits a trigger signal for producing second encoded data to the write-in control unit 15. The write-in control unit 15 reads first encoded data from the recording medium 17 when the write-in control unit 15 receives the trigger signal from the CPU 25. The first encoded data are necessary to be read out from the recording medium 17 at a speed more than twice a recording rate of recording the first encoded data while reading the first encoded data, as mentioned above. Therefore, the first encoded data are stored in the buffer memory “C” 16 temporarily. The first encoded data in constant bit rate read out from the recording medium 17 are decoded by a decoding unit 40, and transmitted to an arithmetic unit 52 and a motion compensation predictive unit 61. In the motion compensation predictive unit 61, first decoded picture data are processed through the motion compensation prediction method in a sequential order of encoding. The arithmetic unit 52 calculates a difference between the first encoded picture data and a predicted picture from the motion compensation predictive unit 61. In a DCT unit 53, differential picture data obtained through the calculation by the arithmetic unit 52 are processed through the DCT method.

A quantizing unit 54 quantizes a DCT coefficient from the DCT unit 53. The quantized data are transmitted to a VLC unit 55 together with a motion vector and an encoding mode from the motion compensation predictive unit 61 and encoded in variable length as a variable length code (VLC) by the VLC unit 55.

The encoded data obtained by the variable length encoding in the VLC unit 55 are stored in the buffer memory “B” 56 temporarily, and then transmitted to the write-in control unit 15. The write-in control unit 15 that is managed by the CPU 25 records the encoded data in the recording medium 17 with bursting as mentioned above.

In the meantime, both an I-picture and a P-picture are necessary to be used for a reference picture for motion compensation prediction in the later process. Therefore, quantized data of the I-picture and the P-picture outputted from the quantizing unit 54 are transmitted to a dequantizing unit 58 and succeeding components. In other words, DCT coefficient data obtained by the dequantizing unit 58 through the dequantizer process are transmitted to an inverse DCT unit 59 and transformed by the inverse DCT process therein. Then, an original picture signal is restored with adding a predictive differential picture from the motion compensation predictive unit 61 in an arithmetic unit 62.

The restored picture signal as mentioned above is stored in a picture memory 60 temporarily. The picture signal that is restored and stored in the picture memory 60 is the same picture signal that is reproduced by a video signal decoding apparatus (will be mentioned later).

The picture signal stored in the picture memory 60 is transmitted to the motion compensation predictive unit 61 and referred to as a reference picture for following motion compensation prediction therein. In other words, the picture signal that is transmitted to the motion compensation predictive unit 61 from the picture memory 60 is used for producing a decoded picture as a reference for calculating a differential picture in the arithmetic unit 62.

A code rate counting unit 64 calculates generated code amounts of the encoded data through the VLC process in the VLC unit 55 and supplies a picture code rate information that shows the generated code amounts to a code rate control unit 65. The code rate control unit 65 controls quantizer steps in the quantizing unit 54 on the basis of the picture code rate information from the code rate count unit 64 and picture target code rate information that will be mentioned later. On the other hand, encoding information that contain generated code amount information and quantization scale information, which are read out from the memory circuit 22, is inputted to a target code rate deciding unit 26.

A target code rate of encoded data in variable bit rate, for example, is set in the target code rate deciding unit 26 by the CPU 25. Usually, the CPU 25 is provided externally. However, it can be provided internally.

Further, setting a target code rate in the CPU 25 is equivalent to inputting an average variable bit rate if a reproduction time of first encoded data in constant bit rate to be converted into encoded data in variable bit rate is known.

An example of algorithm for deciding a code rate in the target code rate deciding unit 26 is described hereinafter.

As mentioned above, with defining such that a generated code amount of each picture observed by the code rate information observing unit 24 is BIT(i), an average quantization scale of total pictures at the generated code amount is Q(i), and a target code rate in total after converting encoded data in constant bit rate into encoded data in variable bit rate is TB, wherein (i) represents a picture number, a total target code rate TG(i) that is applied for each picture of encoded data in variable bit rate can be obtained by following equations.

EN(i)=BIT(i)0.8×Q(i)

TG(i)=TB×EN(i)/ΣEN(i)

A total target code rate or a picture target code rate information TG(i), which is obtained by the above equations and applied for each pictures of encoded data in variable bit rate, is transmitted to the code rate control unit 65. The figure “EN” in the equation is approximately in proportion to complexity and an error rate while compensating motion and represents difficulty of encoding. By increasing a code rate when the “EN” is high and decreasing the code rate when the “EN” is low, assigning a code rate with keeping picture quality constant can be realized. The total target code rate TG applied for each picture of encoded data in variable rate is nothing else but distributing a total target code rate TB, which has been converted into the encoded data in variable bit rate, at the proportion.

Further, the target code rate TG can be simply distributed in proportion to generated code amounts as same manner as the aforementioned prior arts. In addition, controlling a code rate in a picture can be realized by the method of the second step and the following steps mentioned above.

The code rate control unit 65 controls a code rate by controlling a quantizer scale in the quantization unit 54 in accordance with the picture target code rate TG(i) obtained as mentioned above and code rate information counted by the code rate counting unit 64.

According to the video signal encoding apparatus of the present invention, while first encoded data in constant bit rate, for example, are produced and recorded in the recording medium 17, it is enabled that the first encoded data in constant bit rate are converted into encoded data in variable bit rate and recorded in the recording medium 17 through the above-mentioned processing.

Compressed data according to the MPEG encoding standard are defined by affixing 4 bytes of “picture start” code to the head of picture data. The “picture start” code is a byte aligned unique code so as to be distinguished from other data such as “0×00000100”. Therefore, the code rate information observing unit 24 detects the “picture start” code first, and then counts a generated code amount of the picture by counting a code rate until the “picture start” code is detected.

Further, the generated code amount is equivalent to 15 Mbps, although depending on an encoding rate, and is the order of 1.75 Mbits maximum. Additionally, it is acceptable for accuracy of the generated code amount to be the order of 1000 bits. Consequently, the memory circuit 22 is byte-aligned by information equivalent to the order of 11 to 12 bits per picture and records information equivalent to the order of 2 bytes in a sequential order of encoded pictures.

Furthermore, with respect to quantization scale information, it is ideal to obtain the sum or the mean value of quantization scales that are decided by each block of 16 pixels×16 pixels (16×16 pixels), that is, so-called macroblock. In the case of a picture of 740×480 pixels in accordance with the NTSC color television broadcasting system, an average of 1350 macroblocks must be obtained. In this case, essentially, the compressed data must be processed in variable length decode (VLD) down to the macroblock layer that is a relatively deep layer out of the MPEG layers. However, for the purpose of higher speeding, a slice quantization scale that is allocated at the head of the slice layer corresponding to one line of macroblocks can be used for quantization scale information. In the case of a picture of 740×480 pixels in accordance with the NTSC color television broadcasting system, there exists 30 (480/16) slice quantization scales, and the slice quantization scale can be detected among “0×00000101” through “0×0000011E” of a “slice start” code that is a unique code as same as the “picture start” code.

Moreover, the slice quantization scale is shown by 5 bits disposed immediately after the “slice start” code. The code rate information observing unit 24 observes 30 values of the generated code amounts and the quantization scales and obtains the sum or the average of the 30 values.

In addition thereto, a quantization scale is shown by 5 bits from 1 to 31 in either the macroblock layer or the slice layer, so that the quantization scale information can be expressed by 2 bytes. Consequently, the memory circuit 22 records the quantization scale information with adding to the end of generated code amount information.

By the configuration shown in FIG. 1, one example of observing a generated code amount and quantization scale information from first encoded data is explained hereinbefore. It is also acceptable to observe a generated code amount and quantization scale information at the same time encoding by the VLC unit 55.

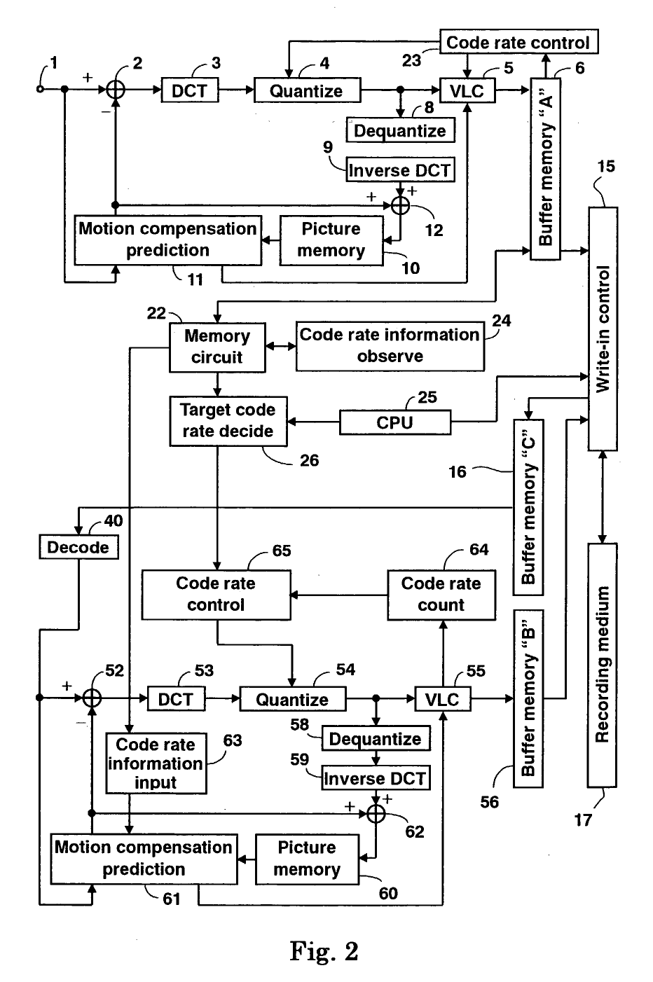

A basic configuration of observing a generated code amount and quantization scale information by the encoding information observing unit 24 at the same time encoding by the VLC unit 55 is shown in FIG. 2.

FIG. 2 is another block diagram of a video signal encoding apparatus showing a configuration of converting a first encoded data into an encoded data in variable bit rate by observing a generated code amount and a motion vector while encoding through an encoding information observation equipment, wherein the video signal encoding apparatus is applied with a variable bit rate encoding method, a variable bit rate encoding apparatus and a variable bit rate encoding program according to the present invention. The video signal encoding apparatus shown in FIG. 2 is identical to that shown in FIG. 1 except for a code rate information input unit 63. Therefore, details of the same operations and functions as those shown in FIG. 1 are omitted.

The code rate information observing unit 24 shown in FIG. 2 observes the sum or the mean value of quantization scales of each macroblock when encoding by counting codes between “picture start” codes, for example. Naturally, as mentioned above, the code rate information observing unit 24 can obtain a slice quantization scale between “slice start” codes instead of obtaining a quantization scale between “picture start” codes. A generated code amount and quantization scale information observed by the code rate information observing unit 24 is stored in the memory circuit 22.

The code rate information input unit 63 reads out motion related information temporally stored in the memory circuit 22, wherein the motion related information is information related to a motion vector and a motion compensation mode. The motion related information are inputted into the motion compensation predictive unit 61.

In a video signal encoding apparatus that adapts the variable bit rate encoding method and the variable bit rate encoding apparatus according to the present invention, a flow chart showing a process of converting first encoded data into encoded data in variable bit rate by observing the first encoded data through the code rate information observing unit 24 is explained next.

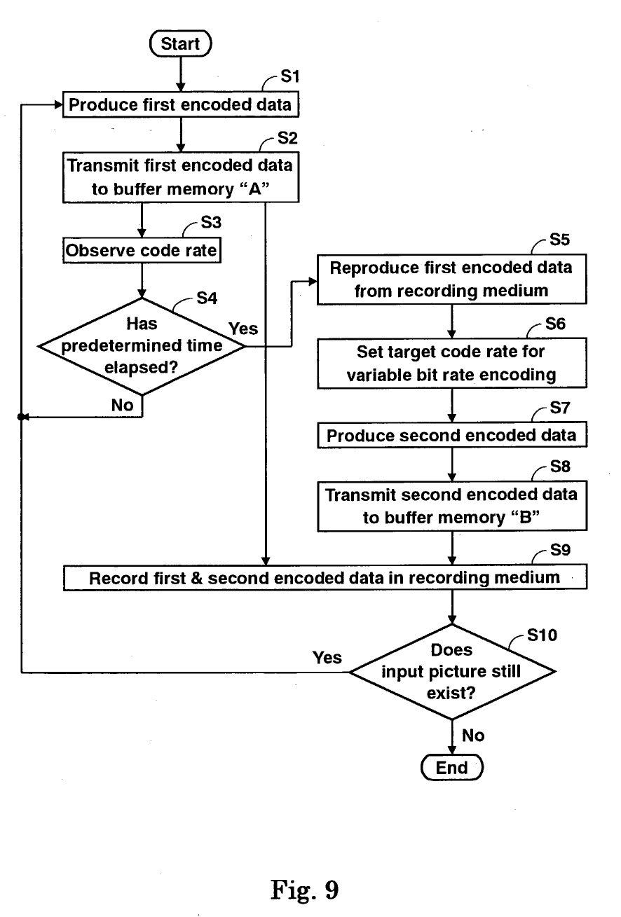

FIG. 9 is a flow chart showing a process of converting first encoded data into encoded data in variable bit rate by observing through an encoding information observing unit in a video signal encoding apparatus, which is applied with the method for variable bit rate encoding, the apparatus for variable bit rate encoding and the program for variable bit rate encoding according to the present invention.

In FIG. 9, first encoded data are produced (step S1), wherein a producing method of the first encoded data is omitted herein because it is identical to the producing method in the video signal encoding apparatus shown in FIG. 1. The first encoded data are transmitted to the buffer memory “A” 6 (step S2), and stored in the memory circuit 22 temporally. Then, a code rate is observed in the code rate information observing unit 24 as mentioned above (step S3).

It is judged whether or not a predetermined time is elapsed (step S4). In a case that the predetermined time is not elapsed yet, the process returns back to the step S1. In a case that the predetermined time is elapsed, the first encoded data are reproduced from the recording medium 17 in accordance with direction from the write-in control unit 15 (step S5). Succeedingly, a target code rate for variable bit rate encoding is set in accordance with information from the code rate observing unit 24 (step S6).

Second encoded data are produced through the variable bit rate encoding process by inputting a reproduced picture (step S7). The second encoded data are transmitted to the buffer memory “B” 56 (step S8). The first encoded data stored in the buffer memory “A” 6 and the second encoded data stored in the buffer memory “B” 56 are recorded with bursting in the recording medium 17 in accordance with directions from the write-in control unit 15 (step S9). It is judged whether or not an input picture still exists (step S10). In a case that an input picture still exists, the process returns back to the step S1. In a case that no more input picture exists, the process comes to end.

As shown in the flow chart of FIG. 9, these steps are sequentially processed. Therefore, these steps seem to be proceeding simultaneously at a glance for a user. In other words, the steps according to the present invention proceed without any operations by the user.

In the video signal encoding apparatus according to the embodiment of the present invention, a flow chart showing a sequence of operations of converting first encoded data into encoded data in variable bit rate by observing a generated code amount and a motion vector information by the code rate information observing unit 24 while encoding is explained next.

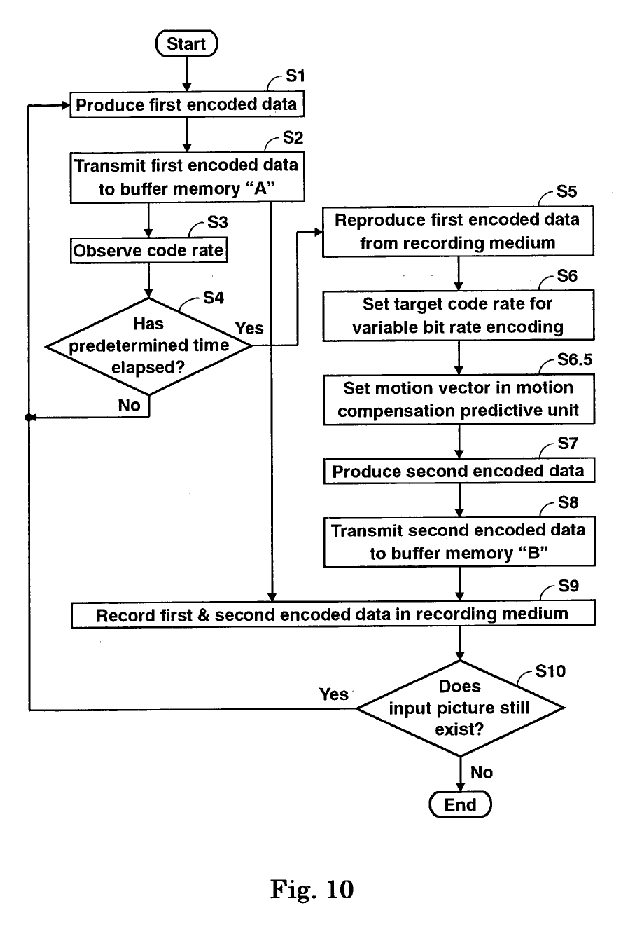

FIG. 10 is a flow chart showing a process of converting a first encoded data into an encoded data in variable bit rate by observing a generated code amount and a motion vector while encoding through an encoding information observing unit in a video signal encoding apparatus, which is applied with the method for variable bit rate encoding, the apparatus for variable bit rate encoding and the program for variable bit rate encoding according to the present invention.

The flow chart shown in FIG. 10 is identical to the flow chart shown in FIG. 9 except for a step S6.5, so that details of some processes are omitted. First of all, first encoded data are produced (step S1). Then, it is judged whether or not a predetermined time is elapsed (step S4). In a case that the predetermined time is not elapsed yet, the process returns back to the step S1. In a case that the predetermined time is elapsed, the first encoded data are reproduced from the recording medium 17 (step S5). Succeedingly, a target code rate for variable bit rate encoding is set in accordance with information from the code rate observing unit 24 (step S6). A motion vector is set in the motion compensation predictive unit 11 in accordance with encoding information (step S6.5). Second encoded data are produced through the variable bit rate encoding process by inputting a reproduced picture (step S7). The second encoded data are transmitted to the buffer memory “B” 56 (step S8). The first encoded data stored in the buffer memory “A” 6 and the second encoded data stored in the buffer memory “B” 56 are recorded with bursting in the recording medium 17 in accordance with directions from the write-in control unit 15 (step S9). It is judged whether or not an input picture still exists (step S10). In a case that an input picture still exists, the process returns back to the step S1. In a case that no more input picture exists, the process comes to end.

According to the video signal encoding apparatus that adapts the variable bit rate encoding method and the variable bit rate encoding apparatus of the present invention, by using the configuration mentioned above, high quality encoded data in variable bit rate, which is equivalent to first encoded data processed through the 2-pass encoding method in a predetermined time unit, can be recorded in the recording medium 17 simultaneously within a minimum delay, that is, the predetermined unit time.

While the invention has been described above with reference to the specific embodiment thereof, it is apparent that many changes, modifications and variations in the arrangement of equipment and devices and in materials can be made without departing from the invention concept disclosed herein. For example, it should be understood that the present invention would not be restricted to the above-mentioned embodiment, and the method of encoding would not be restricted to the MPEG standards.

Further, the above-mentioned embodiment teaches the process as far as the first encoded data and the second encoded data are recorded simultaneously. However, in a case that the first encoded data are not necessary any more after the second encoded data in variable bit rate are obtained, the first encoded data can be erased after the second encoded data are obtained. With respect to timing of the erasing, the first encoded data can be erased collectively after the second encoded data corresponding to continuous input pictures are erased totally, or can be erased by each predetermined unit time after the second encoded data are produced in every predetermined unit time of the present invention.

Further, the first encoded data can be erased by plural units of the predetermined unit time as well.

Furthermore, in this embodiment, a trigger signal for producing second encoded data when first encoded data are recorded up to a predetermined time interval is produced, and then a second encoding is started. The predetermined time interval can be acceptable in any time interval such as one minute, 5 minutes or 10 minutes. If the time interval is less than a reproduction time of contents themselves, an effect of lesser processing time than that by the complete 2-pass encoding can be expected. In a case that the predetermined time interval is one minute or less, a reasonable improving effect of picture quality can be obtained by the variable bit rate encoding process in less buffer and less delay rate although a degree of improving picture quality by the variable bit rate encoding process is not high enough. In other words, a time unit in predetermined time interval can be adjusted for any interval. However, a delay rate and a degree of improving picture quality by the variable bit rate encoding process is in relationship of trade-off, so that it is important to change designing in accordance with a function of application. Generally, a time interval within a range of one minute to 10 minutes is supposed to be the best for total balance.

A recording medium suitable for the present invention is explained next. In the present invention, first encoded data and second encoded data are generated with respect to one program.

Further, the first encoded data and the second encoded data are entitled with a file extension such as “program-name.bs.cbr” and “program-name.bs.vbr” respectively and recorded so as to be identified by their file extensions.

Furthermore, two bit streams of the first and second encoded data are multiplexed in accordance with the MPEG system standard and they can be identified by respective stream ID or program ID.

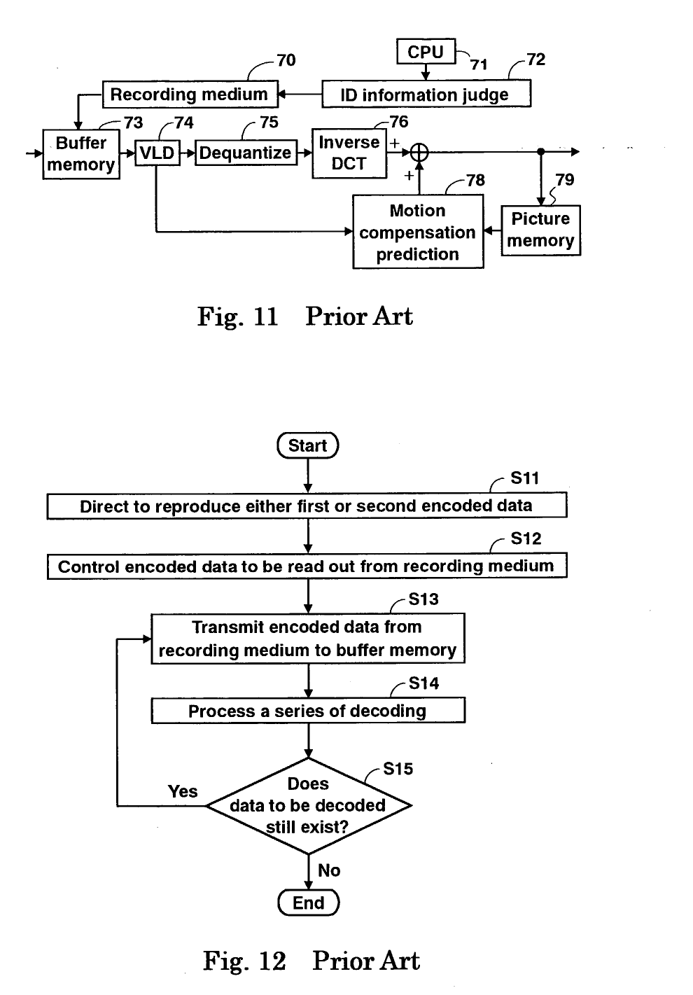

With referring to FIG. 11, a decoding apparatus suitable for the present invention is explained next.

FIG. 11 is a block diagram showing a configuration of a video signal decoding apparatus, which is applied with a method for variable bit rate decoding, an apparatus for variable bit rate decoding and a program for variable bit rate decoding according to the prior art.

In the present invention, first encoded data and second encoded data are generated with respect to one program. As mentioned above, the first encoded data and the second encoded data are entitled by the file extension of “program-name.bs.cbr” and “program-name.bs.vbr” respectively and recorded in a recording medium so as to be identified by their file extensions.

In FIG. 11, a CPU 71 is previously set to direct that encoded data to be decoded is either first encoded data or second encoded data. The CPU 71 transmits a direction signal, which directs to decode either first or second encoded data, to an ID information judging unit 72. It is assumed hereupon that a recording medium 70 is recorded with an ID signal, which directs first encoded data as the file extension of “program-name.bs.cbr” and second encoded data as the file extension of “program-name.bs.vbr” so as to be identified by the file extensions. The ID information judging unit 72 identifies encoded data, which are directed to be decoded, by using a file extension and transmits the encoded data corresponding to the file extension from the recording medium 70 to a buffer memory 73. The encoded data from the buffer memory 73 are inputted into a VLD unit 74. In a case of decoding data in variable bit rate, it is required for an operation that reading out from the recording medium 70 is interrupted temporarily when the buffer memory 73 is in full state and restarted when the buffer memory 73 is below a predetermined value.

In the VLD unit 74, the encoded data are decoded in variable length and a direct current (DC) component and an alternating current (AC) component is obtained. The AC component is arranged in a matrix of 8×8 in accordance with a sequential order of zigzag scanning from a lower frequency to a higher frequency. The decoded data are inputted into a dequantizing unit 75 and dequantized by a quantizer matrix therein. The dequantized data are inputted into an inverse DCT unit 76 and processed through the inverse DCT method, and then outputted as first picture data or decoded data temporally.

Further, the decoded data are stored in a picture memory 79 temporarily, and then used as a reference of decoded picture for counting a differential picture in a motion compensation predictive unit 78.

With referring to FIG. 12, a preferable decoding method is explained next.

FIG. 12 is a flow chart showing an operation of the video signal decoding apparatus shown in FIG. 11. It is assumed hereupon that an ID information for first encoded data and second encoded data, which are generated in one program, is recorded so as to be identified by a file extension such as “programname.bs.cbr” for first encoded data and “program-name.bs.vbr” for second encoded data. In FIG. 12, the CPU 71 is previously set to direct that encoded data to be decoded is either first encoded data or second encoded data (step S11). The CPU 71 transmits a direction signal that directs encoded data to be decoded to the ID information judging unit 72. The ID information judging unit 72 controls encoded data to be read out from the recording medium 70 in accordance with the direction signal transmitted from the CPU 71, wherein the encoded data that is directed to be decoded are identified by a file extension (step S12). Encoded data corresponding to the file extension are transmitted from the recording medium 70 to the buffer memory 73 (step S13). A series of decoding processes is performed (step S14), wherein decoding operations are the same as mentioned above, so that details of decoding are omitted. It is judged per one picture whether or not encoded data to be decoded still exist (step S15). In a case that encoded data still exist, the process returns back to the step S13. In a case that no encoded data exists, the operation comes to end.

In the above-mentioned decoding apparatus and the decoding method, it is assumed that either first encoded data or second encoded data are identified to be decoded after the CPU directs However, always selecting second encoded data in variable bit rate without using a CPU can also be acceptable.

Further, the present invention should involve a program, which realizes functions of the above-mentioned variable bit rate encoding apparatus and variable bit rate decoding apparatus in a computer system. The program can be installed in the computer system by reading out from a recording medium or through a telecommunications network.

As mentioned above, the method for variable bit rate encoding, the apparatus for variable bit rate encoding and the program for variable bit rate encoding according to the present invention is effective for eliminating an extra process of inputting a same picture into a pass twice as the conventional method, apparatus or program does. In other words, with respect to a moving picture signal to be encoded, a picture signal such as a moving picture transmitted in real time through a broadcasting or telecommunications, which is transmitted just once, can be encoded in higher rate and constant bit rate. The encoded data can be recorded in real time into a readable and recordable disc or a tape medium. At the same time, by using the encoded data, the 2-pass encoding into variable bit rate is performed at every predetermined time and encoding equivalent to the 2-pass variable bit rate encoding in higher picture quality is performed within minimal delay. Consequently, encoded data in variable bit rate that is finally necessary can be produced. That is to say, second encoding in variable bit rate is not necessary after first encoding is processed in constant bit rate and all moving pictures are recorded. Therefore, it is effective for enabling to produce encoded data equivalent to 2-pass variable bit rate encoding in higher picture quality within a minimal delay such as the order of a time interval equivalent to one set of input time of inputting picture and a predetermined unit time until final encoded data in variable bit rate are obtained.

Further, when data that are produced by decoding first encoded data are encoded in variable bit rate, at least a parameter related to motion compensation is used. Therefore, it is effective for obtaining high quality encoded data in variable bit rate without being disturbed by an encoding deterioration noise when obtaining a motion vector.

It will be apparent to those skilled in the art that various modifications and variations could be made in the method, apparatus and program for variable bit rate encoding in the present invention without departing from the scope of sprit of the invention.

What is claimed is:

1. A method for variable bit rate encoding, encoding a video signal through an orthogonal transformation and quantization, outputting an encoded video signal in variable bit rate, and recording the encoded video signal, the variable bit rate encoding method comprising the steps of:
obtaining first encoded data by encoding a video signal through the orthogonal transformation and the quantization in a predetermined bit rate;
recording the first encoded data;
observing encoded information of the recorded first encoded data;
decoding the recorded first encoded data at a predetermined time interval;
obtaining second encoded data by encoding the decoded first encoded data in variable bit rate at the predetermined time interval on the basis of either one of a combination of the encoded information and an average variable bit rate to be targeted and another combination of the encoded information and information related to a target code rate; and
recording the second encoded data encoded in the variable bit rate,
the variable bit rate encoding method is further characterized in that the first and second encoded data are recorded in a recording medium while buffering the first and second encoded data respectively in the steps of recording the first and second encoded data.

2. An apparatus for variable bit rate encoding, encoding a video signal through an orthogonal transformation and quantization, outputting an encoded video signal in variable bit rate, and recording the encoded video signal, the variable bit rate encoding apparatus comprising:
a means for obtaining first encoded data by encoding a video signal through the orthogonal transformation and the quantization in a predetermined bit rate;
a means for recording the first encoded data;
a means for observing encoded information of the recorded first encoded data;
a means for decoding the recorded first encoded data at a predetermined time interval;
a means for obtaining second encoded data by encoding the decoded first encoded data in variable bit rate at the predetermined time interval on the basis of either one of a combination of the encoded information and an average variable bit rate to be targeted and another combination of the encoded information and information related to a target code rate; and
a means for recording the second encoded data encoded in the variable bit rate,
the variable bit rate encoding apparatus is further characterized in that the first and second encoded data are recorded in a recording medium while buffering the first and second encoded data respectively when recording the first and second encoded data.

3. A program for variable bit rate encoding, realizing functions of encoding a video signal through an orthogonal transformation and quantization, outputting an encoded video signal in variable bit rate, and recording the encoded video signal in a computer, the variable bit rate encoding program comprising the steps of:
obtaining first encoded data by encoding a video signal through the orthogonal transformation and the quantization in a predetermined bit rate;
recording the first encoded data;
observing encoded information of the recorded first encoded data;
decoding the recorded first encoded data at a predetermined time interval;
obtaining second encoded data by encoding the decoded first encoded data in variable bit rate at the predetermined time interval on the basis of either one of a combination of the encoded information and an average variable bit rate to be targeted and another combination of the encoded information and information related to a target code rate; and
recording the second encoded data encoded in the variable bit rate,
the variable bit rate encoding program is further characterized by functions to be realized in the computer such that the first and second encoded data are recorded in a recording medium while buffering the first and second encoded data respectively in the steps of recording the first and second encoded data.
